(19) United States
(12) Patent Application Publication
(10) Pub. No.: US 2006/0014581 A1
(43) Pub. Date: Jan. 19, 2006

(54) Secure offline betting device

(75) Inventors: Oystein Larsen, Vinterbro (NO); Wictor Nico-laysen, Oslo (NO); Harald Blom, Oslo (NO); Vidar Sandvik, Oslo (NO); Frode Stokke, Oslo (NO)

Correspondence Address: FRISHAUF, HOLTZ, GOODMAN & CHICK, PC, 220 5TH AVE FL 16, NEW YORK, NY, 10001-7708, US

(73) Assignee: CONAX AS, N-0152 Oslo (NO)

(21) Appl. No.: 10/531,344

(22) PCT Filed: Oct. 17, 2002
(86) PCT No.: PCT/NO02/00376

§ 371 Date: Apr. 15, 2005

(51) Int. Cl. G06F 17/00

(52) U.S. Cl. 463/25

(57) ABSTRACT

A method and a secure offline betting device for playing games offered by a betting operator offline and away from the premises of the betting operator, the device thereby comprising a purse application (1), an 1/O controller (2), a games application (3, 13), a cryptologic application (4), a physical 1/O device (9), a random generator application (11) and a logging application (12) all encapsulated in a tamperproof physical enclosure (5).

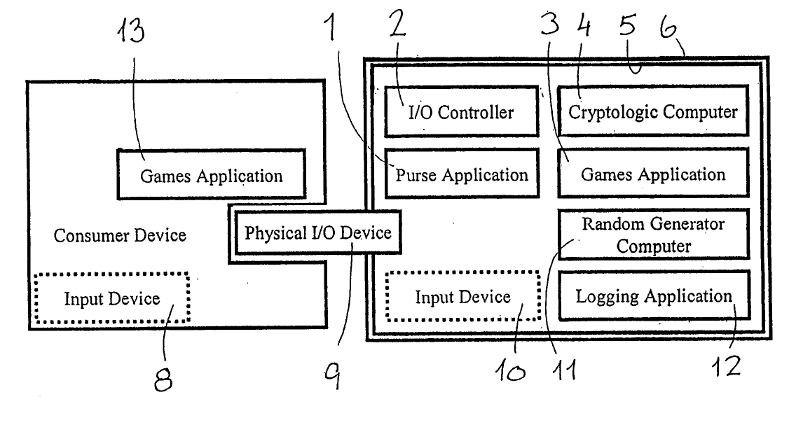

The present invention is related to a secure offline betting device for electronic betting on games offered by a betting operator, outside of the premises of the betting operator, without being online connected to the betting operator.

By using cryptographic techniques (e.g. Public Key Cryptography, Digital Signature, and Public Key Infrastructure) it is possible today to ensure the integrity of data and applications and set specific access privileges to authorised users. Several different means for user identification exist (e.g. PIN code based methods, devices with biometric sensors and more). Several technologies exist for electronic betting systems operated on a computer system in a secure data centre or in a vending machine operated under surveillance. Some betting systems also provide online remote access from a, is cellular phone, PDA, digital TV set-top box or other device. There are today no device that provides these techniques and functionality integrated and combined in a tamper-proof manner to obtain a secure offline betting device.

In many situations it is important and necessary for a betting operator to offer offline electronic betting away from the premises of the betting operator or its reseller. Such situations occur for example in areas where legislation disallows online betting transactions or online payment transactions when used in combination with betting. Users in such areas may be able to play games in their homes, or other places, away from the premises of the betting operator or its resellers, using a tamper proof device that can be loaded/unloaded with money and containing a gaming engine. The offline betting may be performed on a consumer device such as any computer, cellular phone, PDA, digital TV set-top box, or other device.

To comply with such a requirement a gaming device must be able to i) hold a purse that can be loaded and unloaded at a betting operator or its reseller, deducted when a bet is done and topped if a winning, ii) perform the logics of a game (e.g. blackjack, poker, bingo, slot etc), iii) log transactions, iv) generate random numbers, v) encrypt applications and data, vi) hold a set of access privileges, like the gaming operator may load and unload the purse, the user does not have access to change the purse, the user has only access to the gaming engine and vii) only let an authorised operator and authorised user access the betting device.

The above requirements are fulfilled by the secure offline betting device according to the present invention as defined by the features stated in the patent claims. The secure offline device combines and integrates the above-mentioned techniques into a tamper-proof device. This ensures the integrity of the games with winnings and losses as well as only letting an authorised user play games.

With the secure offline mobile betting device according to the invention, a user can be authenticated towards a betting operator i.e. he is allowed to use the secure offline betting device.

The invention will ensure that only an authorised betting operator may load and unload money to/from the betting device. Furthermore it will be ensured that only an authorised betting operator may unload the log from the betting device and that only an authorised user may play the games on the betting device.

The invention also will ensure non-repudiation, i.e. the user of the betting device cannot deny having played games and thereby emptied the purse in the betting device.

According to the invention it further is ensured that, based on signed log information analysis, the winnings on the betting device is within a statistical acceptable pattern, the authorised betting operator is allowed to exchange money hold in the purse with cash

Still according to the invention, logs are gathered from the entire betting device population to analyse winnings and losses to verify that the payout percentage is within the defined range set for the various games

By providing encryption and digital signatures, access to functions in the betting device is only available to an authorised betting operator and an authorised player. The identification may be a PIN code, biometrics etc. If the identification is legal, the betting device will provide access to functions. If not, the betting device will respond that the identification is invalid. If wrong identification is provided more than a predefined number of times, the betting device will be blocked.

The enclosed drawing shows a structural block diagram

The secure offline betting device consists of the following functional blocks: A purse application, a game application, a random generator application, a logging application, a cryptologic application, an I/O controller, a physical 1/O device and optionally an input device. All these sub-devices are encapsulated in a tamperproof physical enclosure, or wrapping.

The purse application holds the money in the secure offline betting device. Money, or tokens, in the purse can be used to play a game or exchanged for cash at a betting operator. The purse application may be loaded at a betting operator or if the user wins a game. The purse may be a running on a shared/dedicated smart card microchip or some other computational device able to perform general computations.

The games application may contain logics for games (e.g. slot, blackjack, poker, bingo, roulette, lotto etc.). The game application may be fully or partially running on a shared/dedicated smart card microchip or some other computational device able to perform general computations or be running fully or partially in the consumer device.

The random generator is an application either running on a shared/dedicated smart card microchip or some other computational device able to perform general computations.

The logging application logs transactions when they are performed. The log data may be un-signed, or signed for security reasons. The logging application may be a running on a shared/dedicated smart card microchip or some other computational device able to perform general computations.

The cryptologic application may be running on a shared or dedicated smart card microchip or some other computational device able to perform cryptographic and security lo functions as well as general computations.

The I/O controller is either dedicated hardware and/or driver software to (necessary) support the communication towards the physical I/O device.

The physical I/O device may be any standard connector (plug) or devices, e.g. USB, ISO 7816 smart card interface, PCMCIA and others.

1. A secure offline betting device for playing games offered by a betting operator offline and away from the premises of the betting operator, characterized in the device comprising a purse application (1), an I/O controller (2), a games application (3, 13), a cryptologic application (4), a physical I/O device (9), a random generator application (11) and a logging application (12) all encapsulated in a tamperproof physical enclosure (5).

2. A method for providing offline betting on games offered by a betting operator, characterized in (i) an authorised betting operator may load and unload the betting device with money or tokens, (ii) an authorised betting operator may load and unload the betting device with entitlements i.e. authorisations for actual games, (iii) an authorised betting operator may unload the transaction log from the betting device, (iv) an authorised user may access information regarding money or tokens hold by the betting device, (v) an authorised user may run games and thereby increase or decrease the money or tokens hold by the betting device, whereby the game may be a slot, blackjack, poker, bingo or any other game.
